(19) United States
(12) Patent Application Publication
(10) Pub. No.: US 2012/0038225 A1
(43) Pub. Date: Feb. 16, 2012

(54) Vertical Bus Disconnect

(76) Inventor: Steven Hunter Grindeland, Franksville, WI (US)

(21) Appl. No.: 13/198,291

(22) Filed: Aug. 4, 2011

Related U.S. Application Data
(60) Provisional application No. 61/372,502, filed on Aug. 11, 2010.

(51) Int. Cl. H02B 1/24

(52) U.S. Cl. 307/112

(57) ABSTRACT

A vertical bus disconnect for Motor Control Center Sections. The invention removes/opens a connection between the horizontal bus and vertical bus when it is in the OPEN or OFF state. The invention creates/closes a connection between the horizontal bus and vertical bus when it is in the CLOSED or ON state. In either the OPEN/OFF state or the CLOSED/ON state, the invention does not cause an interruption of power flow along the horizontal bus. The purpose of the invention is to allow for an isolating of buckets within a given motor control center section from power without interrupting power along the horizontal bus. This invention is an improvement to the commonly used motor control center section.

### CROSS-REFERENCE TO RELATED APPLICATIONS

This system/assembly I have described can be used in the way I described a previous provisional patent(s) which I, Steven Hunter Grindeland, have filed (Application No: 61/372,502, Filing or 371(c) Date Aug. 11, 2010).

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates to Motor Control Center's with a disconnect which connects the horizontal bus to the vertical bus.

Herein, where MCC is used, it is meant to refer to motor control centers as are commonly used for motor control and the like. Where bucket is used; it is meant to refer to subunits of MCC sections/units. Where bus is used; it is meant to refer to the, typically, copper conductors which allow for the flow of power between MCC section/units (in regards to horizontal bus) and between subunits/buckets (in regards to vertical bus).

Presently, in motor control centers, there are no disconnects between the horizontal and vertical bus. MCC's have their horizontal and vertical bus bolted together which allows for free flow of power traveling throughout the bus system. This causes risks of arc flash or otherwise dangerous conditions to a person if they are servicing a bucket within an energized MCC section because there will be energized vertical bus behind the bucket which a technician may be servicing. Commonly, the means for disconnecting power from the bus behind the bucket being serviced, as in the example given, is to disconnect the entire MCC or a large group of MCC sections within the system. This is often problematic or undesirable as there may be loads which are crucial to have power maintained to them (i.e. there may be a case where a hospital has a MCC which feeds power to a multitude of loads from the same MCC or MCC section, some of which could include downstream life support systems). Proper safety methods and procedures are cumbersome, leading to the potential for a person to not engage in the methods and/or procedures that are legally required to work within such a compartment and exposing themselves to unnecessary risks.

It would therefore be desirable to design a Motor Control Center Section with a means for disconnecting it from the overall MCC system or group of sections without interrupting power to the rest of the MCC or group of sections. By being able to do what my invention proposes it would make compliance with laws and regulations less cumbersome.

### BRIEF SUMMARY OF THE INVENTION

My invention electrically isolates the buckets and section of an MCC from the rest of the system. To accomplish this, the preferred embodiment of my invention would incorporate a disconnect which has the purpose of creating an OPEN or CLOSED connection between the horizontal bus and vertical bus without interrupting power along the horizontal bus which allows for power flow amongst the rest of the MCC or a group of sections within an MCC.

### BRIEF DESCRIPTION OF THE DRAWING

The Drawing I have provided demonstrates one solution for a preferred embodiment of the described invention, The drawing is intended to depict my improvement as it would be integrated with typical low-voltage motor control centers,

Displayed in the drawings:

FIG. 1 is a drawing which shows a simple diagrammatic example of a typical low-voltage MCC section with my improvement incorporated into it.

### DETAILED DESCRIPTION OF THE INVENTION

The following description makes reference to line voltage. It is appreciated that such a term may refer to a variety of both common voltage ranges and unique voltages depending on context. However, it is appreciated that the present invention is intended for use in typical low-voltage (<600V) electrical systems and the purpose of the invention is to simplify compliance with safety regulations and procedures during maintenance. A typical example would consist of a system wherein supply voltage is 480 volts 3-phase. My invention describes an improvement to commonly used low-voltage motor control centers. Motor control centers are in common use in the electrical field and often referred to as MCC's.

Referring to the Drawings, a typical arrangement of the components in a preferred embodiment of the invention is shown, The Section or MCC unit, contains within it a disconnecting device as commonly used in applications of electrical systems but in a portion of the circuit where it is not currently used. Components include the disconnecting device, an operating handle, low-voltage motor control center (including horizontal and vertical bus), and MCC buckets.

The general appearance of the invention is similar to that of a common low-voltage motor control centers. However, there are important and distinct differences between the present invention and existing low-voltage motor control center designs.

In motor control centers, there is currently no utilized method of disconnecting any singular MCC section from the overall system without interrupting power from the rest of the system. This causes risks of arc flash and otherwise dangerous conditions to a person that is exposed to a bucket that follows this conventional means of assembly. Proper safety methods and procedures are cumbersome, leading to the potential for a person to not engage in the methods and/or procedures that are legally required to work within such a compartment and exposing themselves to unnecessary risks.

The present invention is distinctly different from existing; I will expound upon the differences and improvements.

The first distinction is that in the preferred embodiment of my invention requires, an additional component, a currently unutilized disconnecting device (e.g. non-trip disconnect, rotary disconnect, or the like) in the proper location with respect to the electrical circuit or bus system. Currently, MCC's are not manufactured or made with a disconnecting device in the location which I am describing. This disconnecting device would MAKE or BREAK the connection between the vertical and horizontal bus respective to the section for which it is incorporated. In the preferred embodiment of my invention, this disconnecting device would be incorporated as an integral component to the MCC section; it is appreciated however, that a section could be modified to incorporate a disconnecting device in the way which I describe.

It is a purpose of my invention to simplify compliance with safety regulations, thereby encouraging compliance.

It is also a purpose of my invention to make it easier to isolate vertical MCC sections apart from the MCC lineup without interrupting power to the rest of the system and thereby making it more practical to isolate a set of given buckets within a MCC section.

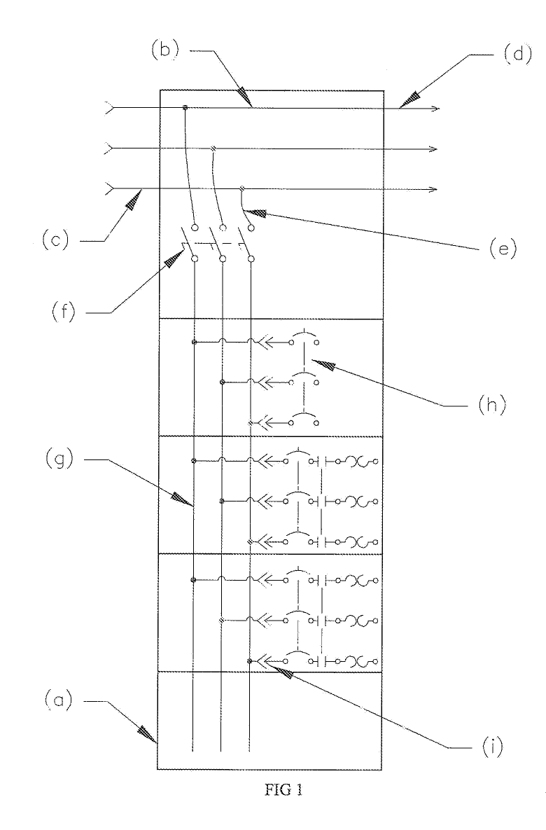

Referring to the drawing, FIG. 1, that I have provided; I will here go into describing the components which make up the improved MCC section that is the preferred embodiment of my invention.

Referring to FIG. 1, (a) is representing a structure which is similar to that of a commonly used MCC section. In the drawing I have included a visual example of my improvement to the currently used MCC section.

Referring again to FIG. 1, (b) is a representation of the horizontal bus that is commonly used in MCC sections. I have placed it in the top for the preferred embodiment of my invention but it is appreciated that this horizontal bus could be located anywhere along the vertical axis within the MCC section. The horizontal bus, which is typically a group of 3 or 4 copper conductors is shown here as 3 conductors as would be common for a 480V 3-phase 3-wire system.

Referring again to FIG. 1, (c) is indicating one side, left in this case, of where power is transferred between this MCC section and any adjacent one. It is appreciated that if this were an end section to a lineup of MCC sections (apart from being adjacent to the incoming main) that there may not be a connection to another MCC section on this side of the displayed MCC section example.

Referring again to FIG. 1, (d) is indicating one side, right in this case, of where power is transferred between this MCC section and any adjacent one. It is appreciated that if this were an end section to a lineup of MCC sections (apart from being adjacent to the incoming main) that there may not be a connection to another MCC section on this side of the displayed MCC section example.

Referring again to FIG. 1, (e) is meant to represent a connection between the horizontal bus and a disconnecting device (e.g. non-fused disconnect, rotary disconnect, or the like). This is an essential part of my invention. This connection would be used, in part, in place of bolting the vertical bus to the horizontal. This is representing a set of conductors (e.g. cabling, modified bus bars, copper conductors, or the like) which connect on one end to the horizontal bus and on the other to the line side of the disconnect which OPENS or CLOSES the connection to the vertical bus.

Referring again to FIG. 1, (f) is meant to represent the disconnecting device that is

OPENS or CLOSES a connection to the vertical bus from the horizontal bus. I am referring to this device as the “vertical bus disconnect”. In the CLOSED or ON state, this disconnect makes a completed circuit between the horizontal and vertical bus. In the OPEN or OFF state, this disconnect makes a open circuit between the horizontal and vertical bus and thusly removing power from the vertical bus while causing no interruption of power along the horizontal bus.

Referring again to FIG. 1, (g) is meant to represent the vertical bus of a common MCC section. However, in this case the vertical bus is not bolted to the horizontal bus as it is commonly. The vertical bus in this case is connected to the load side of the disconnecting device within the MCC section and can only allow power to the buckets contained within the MCC section when its respective disconnect is in the CLOSED or ON state. When the disconnect within its respective MCC section is in the OPEN or OFF state, the vertical bus to which it is connected (within the same MCC section) is completely de-energized and can thereby not deliver power to the buckets within the given MCC section

Referring again to FIG. 1, (h) is meant to represent a typical bucket within an MCC section. This bucket, typically, would connect to the vertical bus via what are referred to commonly as “stabs”. In the preferred embodiment of my invention, when the vertical bus disconnect is in the OPEN or OFF state; no power would be fed to this bucket. When the vertical bus disconnect is in the CLOSED or ON state; power would potentially be fed to this bucket (assuming no upstream disconnects or bad connections would be preventing it).

Referring again to FIG. 1, (i) is meant to represent a typical “stab” unit, as it is commonly referred to as. This is a common component of MCC structures and are used to create a connection between the vertical bus of the section with and buckets that are plugged into the section.

Referring again to FIG. 1, the way in which my invention, in my preferred embodiment, would be used is in cases were a technician would want to isolate a bucket or buckets within the section from line power for servicing or otherwise. The technician would switch the vertical bus disconnect to the OPEN or OFF state, then following proper procedures and methods, they would service any bucket within the section that now has its vertical bus de-energized. When doing what I have explained; power would not be removed from the horizontal bus and therefore there would be no interruption of power for any other MCC sections within the lineup from servicing this de-energized section.

To manufacture my invention:
The manufacturing entity would mount and wire or modify/alter the current method of manufacturing motor control center section(s)/unit(s) as necessary for each of the following aspects of the electrical motor control center assembly within their respective compartments, while following the necessary guidelines that I have previously laid out within this document.
   Disconnecting device(s)
   Auxiliary device(s)
   Motor Control Center Unit(s)
   Motor Control Center Subunit(s)
   Conductors
   Doors and cover plates as necessary
   Motor Controllers
   Lugs
   ay(s)/Gutter(s)
   Other Devices, as necessary (e.g. auxiliary contacts, voltage testing terminals, conductors, mechanical linkage, and the like)
The compartments should be arranged in such a way to allow for operation and interaction of the complete system in the mode that I have described within this document.
In the preferred embodiment of my invention; all of the individual components would be arranged and/or mounted within a motor control center section/unit or arranged in such a way as to carry out the same operation in the way that I have previously described,

I have herein described the preferred embodiment of the present invention in one form that would be useful for electrical motor control centers. The specific arrangement may vary depending on project specific requirements, and desired optional features. It is recognized that equivalents, alternatives, and modifications, aside from those expressly stated, are possible and within the scope of the appending claims.

What I claim as my invention is:

1. A vertical bus disconnect for motor control centers, which in the OPEN or OFF state, electrically isolates the vertical bus from the horizontal bus and when in the CLOSED or ON state, creates a connection and continuity between the vertical bus and horizontal bus (with respect to the motor control section for which it is mounted in or integral thereto).
